(19) United States
(12) Patent Application Publication
(10) Pub. No.: US 2026/0270578 A1
(43) Pub. Date: Sep. 10, 2026

(54) PHOTOELECTRIC CONVERSION APPARATUS AND EQUIPMENT

(71) Applicant: CANON KABUSHIKI KAISHA, Tokyo (JP)

(72) Inventors: ATSUSHI SUZUKI, Kanagawa (JP); JUMPEI ASHIDA, Cupertino, CA (US)

(21) Appl. No.: 19/649,350

(22) Filed: Apr. 16, 2026

Related U.S. Application Data
(63) Continuation of application No. PCT/JP2024/033073, filed on Sep. 17, 2024.

(30) Foreign Application Priority Data
Oct. 25, 2023 (JP) 2023-183529

(51) Int. Cl. H04N 25/47; H04N 25/707

(52) U.S. Cl. CPC H04N 25/47; H04N 25/707

(57) ABSTRACT

A photoelectric conversion apparatus in which a plurality of pixel blocks, each includes a plurality of first pixels, a determination unit, and an addition unit, are arranged. Each of the plurality of first pixels includes a first detection unit configured to detect light and output a detection signal, and a first counter configured to count the detection signal output per a first time period and output a count value. The determination unit performs detection of an event based on the count value of the first counter, and the addition unit accumulates outputs of the first counter over a second time period, and outputs the accumulated output as an image signal.

### CROSS-REFERENCE TO RELATED APPLICATIONS

This application is a Continuation of International Patent Application No. PCT/JP2024/033073, filed Sep. 17, 2024, which claims the benefit of Japanese Patent Application No. 2023-183529, filed Oct. 25, 2023, which is hereby incorporated by reference herein in its entirety.

### BACKGROUND

### Field of the Technology

The present disclosure relates to a photoelectric conversion apparatus and equipment.

### Description of the Related Art

Along with the recent spread of IoT, AI, automated driving, and the like, there is a demand for high-speed image sensors with less power consumption. As one of them, an asynchronous sensor called an event-based sensor or a dynamic vision sensor has been proposed. Japanese Patent Laid-Open No. 2020-096347 describes a solid-state image capturing element where a pixel that detects a change in light amount exceeding a threshold as an address event for each pixel address and a pixel that outputs a pixel signal are arranged. Japanese Patent Laid-Open No. 2020-057949 describes a solid-state image capturing apparatus that reads out a pixel signal based on the detection result of an address event.

### SUMMARY

According to one aspect of the present disclosure, there is provided a photoelectric conversion apparatus, which is arranged with a plurality of pixel blocks, each including a plurality of first pixels, a determination unit, and an addition unit, wherein each of the plurality of first pixels includes a first detection unit configured to detect light and output a detection signal, and a first counter configured to count the detection signal output per a first time period and output a count value, the determination unit performs detection of an event based on the count value of the first counter, and the addition unit accumulates outputs of the first counter over a second time period, and outputs the accumulated output as an image signal.

Features of the present disclosure will become apparent from the following description of embodiments with reference to the attached drawings.

### BRIEF DESCRIPTION OF THE DRAWINGS

FIG. 1 is a view showing the schematic configuration of a photoelectric conversion apparatus according to the first embodiment;

FIG. 2 is a view showing an example of the configuration of a pixel block according to the first embodiment;

FIG. 3A is a view showing an example of the arrangement of color filters of pixels in the pixel block according to the first embodiment;

FIG. 3B is a view showing an example of the arrangement of color filters of pixels in the pixel block according to the first embodiment;

FIG. 3C is a view showing an example of the arrangement of color filters of pixels in the pixel block according to the first embodiment;

FIG. 4 is a view showing an example of the arrangement of pixels in the pixel block according to the first embodiment;

FIG. 5 is a view showing an example of the circuit configuration of a pixel according to the first embodiment;

FIG. 6 is a view showing an example of memory allocation of a storage unit according to the first embodiment;

FIG. 7 is a timing chart showing an operation according to the first embodiment;

FIG. 8 is a view showing an example of the arrangement of pixels according to the second embodiment;

FIG. 9 is a view showing an example of memory allocation of a storage unit according to the second embodiment;

FIG. 10 is a timing chart showing an operation according to the second embodiment;

FIG. 11 is a flowchart according to the third embodiment;

FIG. 12 is a view showing an example of the configuration of a pixel block according to the fourth embodiment;

FIG. 13 is a view showing an example of the circuit configuration of a pixel according to the fourth embodiment;

FIG. 14 is a view showing an example of memory allocation of a storage unit according to the fourth embodiment;

FIG. 15 is a timing chart showing an operation according to the fourth embodiment;

FIG. 16 is a view showing an example of the configuration of a pixel block according to the fifth embodiment; and

FIG. 17 is a view showing an application example of the photoelectric conversion apparatus according to the embodiment to equipment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In the embodiments described below, as an example of a photoelectric conversion apparatus, an image capturing apparatus capable of event detection will mainly be described. However, the photoelectric conversion apparatus in each embodiment is not limited to the image capturing apparatus, and is also applicable to another light detection apparatus based on photoelectric conversion. Examples of the other light detection apparatus are a distance measurement apparatus and a focus detection apparatus.

### First Embodiment

### Configuration of Photoelectric Conversion Apparatus

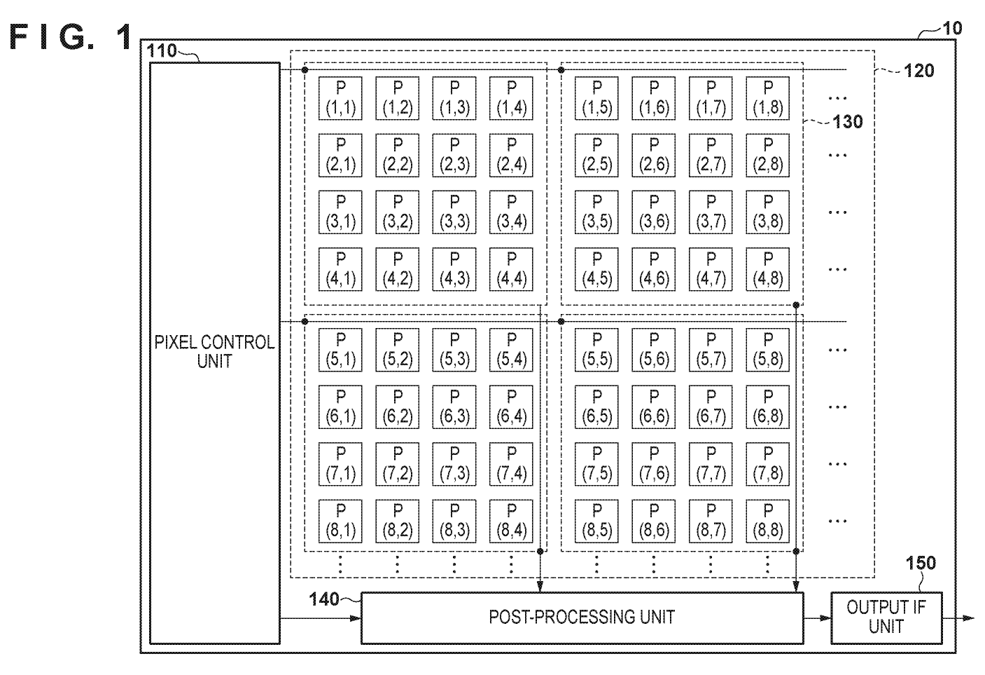

The schematic configuration of a photoelectric conversion apparatus 10 will be described with reference to FIG. 1. The photoelectric conversion apparatus 10 includes a pixel array portion 120. In the pixel array portion 120, a plurality of pixel blocks 130 are arranged in a matrix. In the pixel block 130, pixels (indicated by P(i, j)) are arranged in a matrix. FIG. 1 shows the pixels arranged in a matrix of four rows × four columns in the pixel block 130, but the arrangement is not limited thereto. The pixels may be arranged in sixteen rows × sixteen columns or four rows × two columns in the pixel block 130. A pixel control unit 110 can perform control for scanning the pixel array and reading out signals from the pixels. A post-processing unit 140 can perform reordering or correction processing on signals read out from the pixels. An output IF unit 150 can output the signal having undergone post-processing by the post-processing unit 140 to the outside of the photoelectric conversion apparatus 10.

### Configuration of Pixel Block

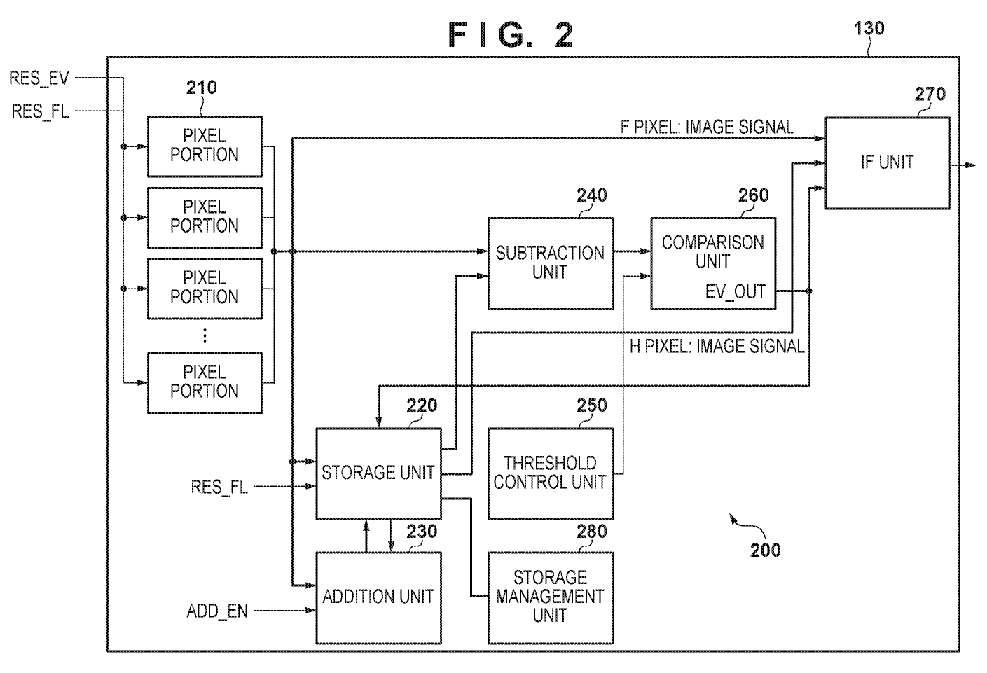

Next, the configuration of the pixel block 130 will be described with reference to FIG. 2. The pixel block 130 can include pixel portions 210, a determination unit 200 that performs detection of an event, and an output interface (IF) unit 270. The determination unit 200 can include a storage unit 220, an addition unit 230, a subtraction unit 240, a threshold control unit 250, a comparison unit 260, and a storage management unit 280.

Each of the pixel portions 210 shown in FIG. 2 represents one unit of pixel. When the pixels are arranged in a matrix of four rows × four columns in the pixel block 130, the pixel block 130 includes sixteen pixel portions 210. There are two kinds of pixel portions 210: a pixel for generating a frame image (to be referred to as an "F pixel" hereinafter), and a pixel for generating a frame image and performing event detection (to be referred to as an "H pixel" hereinafter). Here, event detection includes determination as to whether the output value of the pixel corresponding to the incident light amount has changed more than a predetermined value. In event detection, if the difference value between the incident light amount and a reference value for event detection at a given time exceeds a predetermined threshold, it can be determined that an event has occurred. In this case, an event detection signal can be generated. As will be described later, the F pixel and the H pixel include counters for acquiring signals used for event detection and frame image generation. The counters of the H pixel and F pixel are controlled by an event counter reset signal RES_EV and an image counter reset signal RES_FL, and can output count values corresponding to the incident light in accordance with the cycles of the respective reset signals. The count value output from the pixel portion 210 is input to each of the storage unit 220, the addition unit 230, the subtraction unit 240, and the IF unit 270.

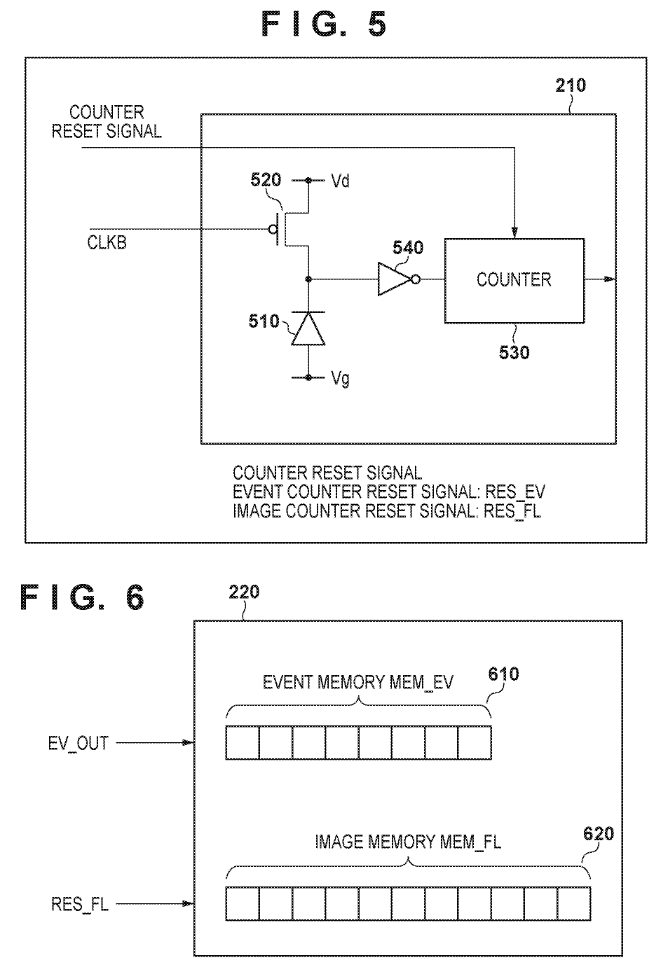

Here, the configuration of the pixel portion 210 will be described with reference to a circuit example of the pixel portion 210 shown in FIG. 5. A circuit that detects light by an SPAD (Single Photon Avalanche Diode) is illustrated here. A photoelectric conversion element 510 where light enters is, for example, an avalanche photodiode (to be referred to as an "APD" hereinafter). The photoelectric conversion element 510 is connected to a quenching element 520. In this example, a first power supply voltage Vd is applied to the cathode of the photoelectric conversion element 510 via the quenching element 520, and a second power supply voltage Vg is applied to the anode of the photoelectric conversion element 510. A pixel control signal CLKB is input to the control terminal of the quenching element 520. Here, the APD is set to operate in a Geiger mode. In this example, a PMOS transistor is used for the quenching element 520, and the quenching element is configured using the resistance component of the transistor.

In the Geiger mode, a predetermined bias voltage is applied as the pixel control signal CLKB to the gate of the PMOS transistor. When a photon enters the APD serving as the photoelectric conversion element 510, an avalanche current flows due to avalanche multiplication. When the avalanche current flows, the cathode voltage of the APD drops from the first power supply voltage due to the resistance component of the quenching element 520. When the cathode voltage drops and becomes equal to or lower than the breakdown voltage of the APD, the cathode voltage rises again. This change in the cathode voltage is input as a light detection signal to a counter 530 by an inverter 540.

While no photon enters, high level is input to the inverter 540. On the other hand, when a photon enters, low level is input. Accordingly, a light detection signal corresponding to the incident photon is output from the inverter 540. A circuit including the photoelectric conversion element 510, the quenching element 520, and the inverter 540, and configured to generate a light detection signal functions as a light detection unit.

By counting the number of light detection signals by the counter 530, the number of photons entering the APD within a set unit time can be counted. The counter 530 is controlled by a signal having a cycle corresponding to the unit time, and the count value corresponding to the number of photons entering within each unit time is output from the pixel portion 210. The counter 530 is reset by a signal also having a cycle corresponding to the unit time, and can start the next counting.

As the signal having a cycle corresponding to the unit time, a signal for detecting an event and a signal for outputting an image signal can be supplied to the pixel. The signal for resetting the counter 530 to detect an event is indicated by the event counter reset signal RES_EV. The signal for resetting the counter 530 to output an image signal is indicated by the image counter reset signal RES_FL. The event counter reset signal RES_EV and the image counter reset signal RES_FL can have different cycles.

Referring back to FIG. 2, the pixel block 130 will be described. The storage unit 220 includes a memory area for saving a reference value for event detection, and a memory area for frame image generation. The addition unit 230 adds the count value, which is counted and output by the counter 530 controlled by the event counter reset signal RES_EV, to data stored in the memory area for frame image generation of the storage unit 220. The subtraction unit 240 subtracts, from the count value output from the counter 530 controlled by the event counter reset signal RES_EV, the reference value for event detection stored in the storage unit 220, and outputs the obtained value. Based on the change amount of the count value from the reference value, occurrence of an event can be detected.

The threshold control unit 250 can control the threshold used to determine occurrence of an event. The threshold control unit 250 can control the threshold according to the driving mode of the photoelectric conversion apparatus such as the incident light amount, the time for storing the reference value, or the detection frequency. If the change amount of the signal obtained by subtraction by the subtraction unit 240 exceeds the threshold, it is determined that an event has occurred. This state is referred to as on-event. If the change amount is below the threshold, it is determined that no event has occurred. This state is referred to as off-event. The threshold can also be controlled according to the frequency of event occurrence or the number of event occurrences. By providing the threshold control unit 250 for each pixel block 130, it is possible to appropriately control the threshold and detect occurrence of an event with high accuracy. The comparison unit 260 compares the output value from the subtraction unit 240 with the threshold, and outputs an event detection signal EV_OUT if a change exceeding the threshold is detected. The event detection signal EV_OUT and the image signal can be output to the outside of the pixel block 130 via the IF unit 270.

### Storage Unit

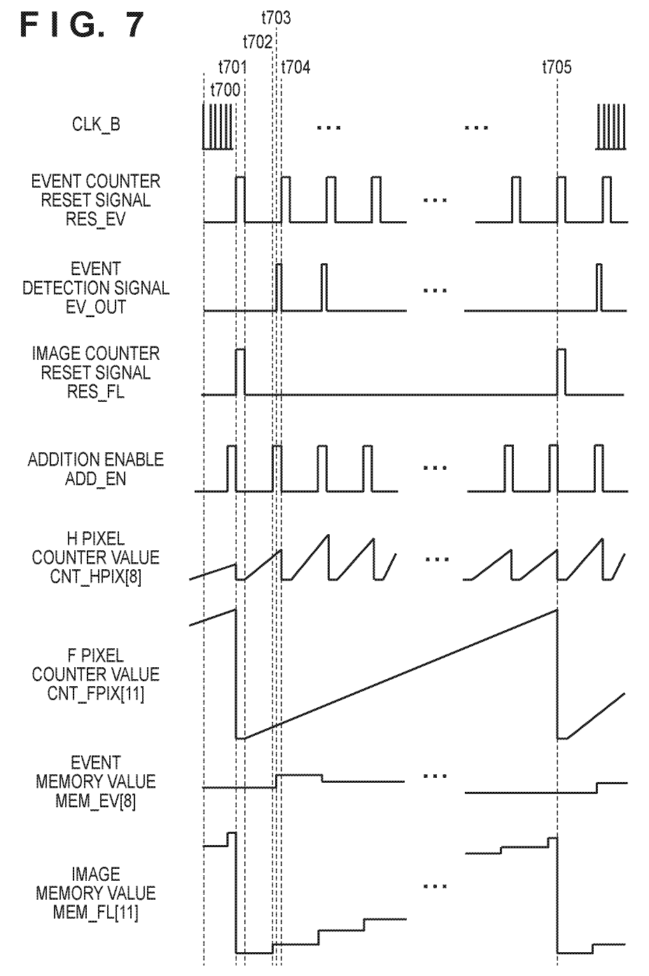

Next, the storage unit 220 will be described with reference to FIG. 6. FIG. 6 is a view showing memory allocation. The storage unit 220 is allocated with an event memory area MEM_EV for storing an event reference value used in event detection, and an image memory area MEM_FL for storing the count value accumulated to generate an image signal. The event memory area MEM_EV and the image memory area MEM_FL can be provided in the storage unit 220 so as to correspond to each H pixel arranged in the pixel block.

The event memory area MEM_EV is a memory for saving the reference value for determining event detection, and saves the count value of the H pixel at a given time. If an event is detected, the reference value stored in the event memory area MEM_EV is updated under the control of the storage management unit 280. The update operation will be described later with reference to FIG. 7. The image memory area MEM_FL is a memory used to generate frame image data based on the count value of the counter 530 which is controlled by the event counter reset signal RES_EV. In the image memory area MEM_FL, the count value read out at the cycle of the event counter reset signal RES_EV during one cycle of the image counter reset signal RES_FL is sequentially added. The data in the image memory area MEM_FL is output to the IF unit 270 at the cycle of the image counter reset signal RES_FL. When the data is output, the image memory area MEM_FL is reset. Note that the update of the reference value by the storage management unit 280 is merely an example. As another example, the reference value stored in the event memory area MEM_EV may be updated using a count value CNT_HPIX of the H pixel and the event detection signal EV_OUT.

Here, the cycle of event detection can normally be set shorter than the cycle of image signal acquisition, so that the cycle of the event counter reset signal RES_EV can be set shorter than the cycle of the image counter reset signal RES_FL. Hence, if the counter 530 shown in FIG. 5 has a bit length of 11 bits, an output from the F pixel can have a data length of 11 bits while an output from the H pixel may have a data length of 8 bits. Accordingly, when the F pixel outputs an image signal having a data length of 11 bits, the image memory in the image memory area MEM_FL needs to have a data length of 11 bits, but the event memory area MEM_EV need only have a data length of 8 bits. Note that the ratio of the event memory area and the image memory area and the capacity thereof in the storage unit can be changed in accordance with the event detection cycle, the image signal cycle, or the ratio of the F pixels and the H pixels in the pixel block.

### Pixel Arrangement Example

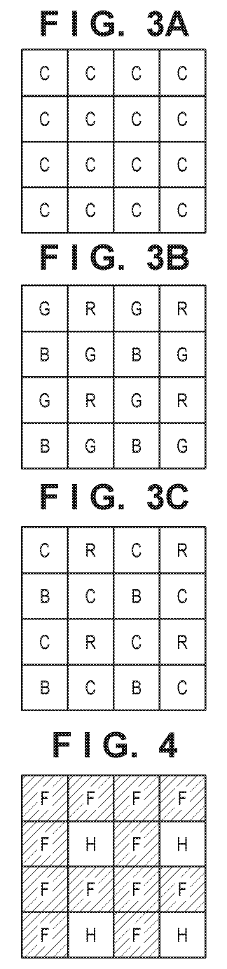

FIGS. 3A to 3C show arrangement examples of color filters in the pixels in the pixel block 130. In FIGS. 3A to 3C, R, G, and B indicate red, green, and blue color filters, respectively, and the pixels arranged with these are pixels that mainly perform image capturing. FIG. 3A shows the arrangement for detecting a gray scale when all pixels include transparent filters. FIG. 3B shows an example of a Bayer array. FIG. 3C shows an example of an RCCB array obtained by replacing green G in the Bayer array with transparent C.

Next, an arrangement example of the F pixels and the H pixels will be described with reference to FIG. 4. In this embodiment, the F pixel outputs a count value to the IF unit 270 at each image readout cycle. The H pixel outputs a count value to the storage unit 220, the addition unit 230, and the subtraction unit 240 at each event detection cycle. The arrangement of the F pixels and the H pixels is not limited to the arrangement shown in FIG. 4. The pixel block 130 may include only one H pixel, or all pixels may be the H pixels. The arrangement and numbers of F pixels and H pixels may be changed for each event detection or in accordance with the change of the incident light amount, the information of defect pixel, or the change of the driving method of the H pixels and F pixels.

### Timing Chart

FIG. 7 is a timing chart showing an operation according to the first embodiment. Time t700 is a time to start reset of the event detection counter and the frame image generation counter. The reset operations of the counters are controlled by the event counter reset signal RES_EV and the image counter reset signal RES_FL. At time t700, the event counter reset signal RES_EV and the image counter reset signal RES_FL change from low level to high level.

The count value of the H pixel can have a length of 8 bits. The count value CNT_HPIX[8] of the H pixel is reset by the event counter reset signal. The count value of the F pixel can have a length of 11 bits. The count value CNT_FPIX of the F pixel and the data in the image memory area MEM_FL[11] for frame image generation are reset by the image counter reset signal RES_FL. Note that the number in [] indicates an example of the bit length of data.

At time t701, the event counter reset signal RES_EV and the image counter reset signal RES_FL change from high level to low level, so that the reset of the counters are released and the event detection period and frame image generation period are started. When a photon enters the APD serving as the photoelectric conversion element 510 in the pixel portion 210, the counter 530 counts a light detection signal, and a count value corresponding to the incident light amount in each of the event detection period and the frame image generation period is output. In this manner, the counter of the H pixel counts the number of photons in the event detection period which is controlled by the event counter reset signal RES_EV. On the other hand, the counter of the F pixel counts the number of photons in the frame image generation period at the cycle controlled by the image counter reset signal RES_FL.

At time t702, an addition enable ADD_EN input to the addition unit 230 changes from low level to high level. With this, the addition unit 230 adds the count value CNT_EV[8] of the H pixel to the data stored in the image memory area MEM_FL[11] of the memory to perform accumulation, updates the data, and saves it in the image memory area MEM_FL[11]. The count value CNT_EV[8] of the H pixel is added to the image memory area MEM_FL[11] at each event cycle.

At time t703, it is determined whether an event has occurred. The count value of the H pixel at a reference time is held in the event memory area MEM_EV[8] in advance as the reference value. The subtraction unit 240 calculates a difference value between the count value CNT_HPIX[8] of the H pixel and the event memory area MEM_EV[8] (that is, CNT_HPIX[8] - MEM_EV[8]), and outputs it to the comparison unit 260. The comparison unit 260 compares the difference value with a threshold output from the threshold control unit 250. If the difference value is greater than the threshold, it is determined to be on-event, and occurrence of an event is detected. If occurrence of an event is detected, the event detection signal EV_OUT is switched from low level to high level, and the event detection signal EV_OUT (high level) is output from the comparison unit 260. When the event detection signal EV_OUT is switched to high level, the count value CNT_HPIX[8] of the H pixel corresponding to detection of the event is saved in the event memory area MEM_EV[8] as a new reference value. Note that positive and negative thresholds may be prepared, and an event may be detected if the value is greater than the positive or negative threshold.

At time t704, the event detection counter of the H pixel is reset again. The event counter reset signal RES_EV changes from low level to high level, the count value CNT_HPIX[8] of the H pixel is reset, and the H pixel transitions to the next event detection cycle. On the other hand, the count value of the H pixel output from the counter at each event detection cycle is accumulated in the image memory area MEM_FL[11]for image signal generation. The accumulation is performed until time t705 when the image memory area MEM_FL[11] is reset by the image counter reset signal RES_FL. The data stored in the image memory area is data corresponding to the count values counted by the counter of the F pixel in the same period. That is, the data equivalent to the image signal of the F pixel is held in the image memory area MEM_FL[11].

At time t705, the count period of the frame image generation counter ends. The count value CNT_FPIX of the F pixel is input as the image signal of the F pixel from the pixel portion 210 to the IF unit 270, and is externally output. The data of the image memory area MEM_FL[11] is also input to the IF unit 270 and externally output as the image signal of the H pixel.

In this manner, event detection and image signal acquisition in the H pixel and image signal acquisition in the F pixel can be performed simultaneously in parallel. The image signal output from the pixel block 130 can include not only the image information from the F pixel but also the image information from the H pixel. Since the image signal can be acquired from the H pixel simultaneously with event detection, no image signal loss occurs, unlike a case where pixels for event detection are arranged. Therefore, pixel signal complementing processing is not required. This can achieve reduction of the processing load and suppress degradation of image quality. Furthermore, it is possible to perform event detection while counting image signals. This can prevent temporally discontinuous event detection, thereby improving event detection accuracy.

### Second Embodiment

Differences from the first embodiment will mainly be described, and a description of parts that overlap the first embodiment will be omitted. In this embodiment, by changing the allocation of memory area for H pixels in a storage unit, the number of pixels for event detection in a pixel block 130 can be increased. This can increase the resolution of event detection.

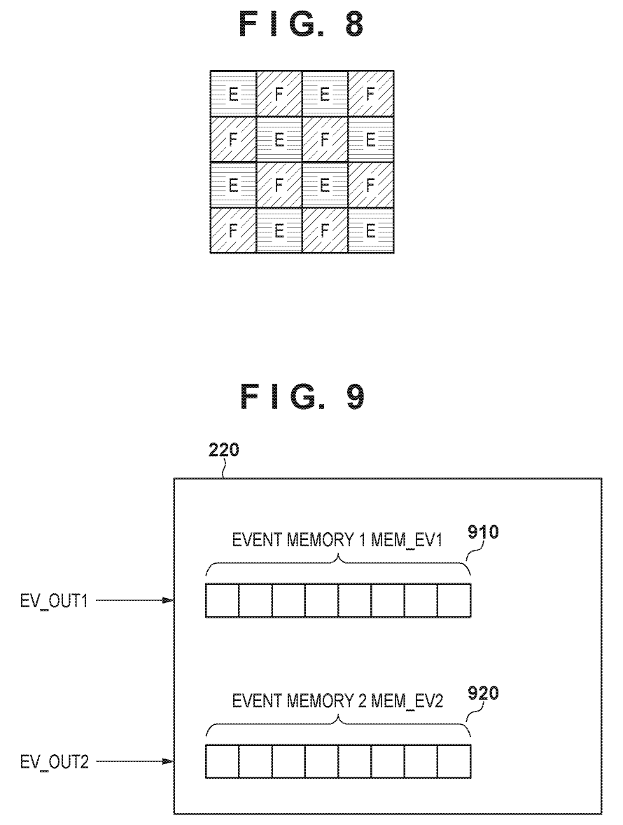

FIG. 8 shows an example of pixel allocation in the pixel block in the second embodiment. Here, a pixel E indicated by "E" is a pixel for event detection, which is an H pixel or an F pixel assigned for event detection (to be referred to as an "E pixel" hereinafter). In other words, FIG. 8 shows an example in which H pixels and some F pixels in the pixel arrangement shown in FIG. 4 are replaced with E pixels. In the example shown in FIG. 8, the number of pixels that can be used for event detection is doubled compared to the example shown in FIG. 4.

FIG. 9 is a view showing memory allocation of a storage unit 220 in the second embodiment. In the storage unit 220, in addition to an event memory 1 area MEM_EV1 for storing a reference value, the image memory area MEM_FL[11] allocated for image signal accumulation is allocated as an additional event memory 2 area MEM_EV2. A storage management unit 280 can change the allocation of memory area. The event memory 1 area MEM_EV1 and the additional event memory 2 area MEM_EV2 are memory areas for storing reference values for event detection with respect to different E pixels. When two E pixels are referred to as an E1 pixel and an E2 pixel, the event memory 1 area MEM_EV1 can store the reference value for the E1 pixel, and the additional event memory 2 area MEM_EV2 can store the reference value for the E2 pixel. If occurrence of an event is detected, an event detection signal EV_OUT1 of the E1 pixel or an event detection signal EV_OUT2 of the E2 pixel is output. The data in the event memory 1 area MEM_EV1 and the data in the additional event memory 2 area MEM_EV2 are updated in accordance with output of the corresponding event detection signal EV_OUT. The data length of each of the event memory 1 area MEM_EV1 and the additional event memory 2 area MEM_EV2 may be 8 bits, as in the first embodiment.

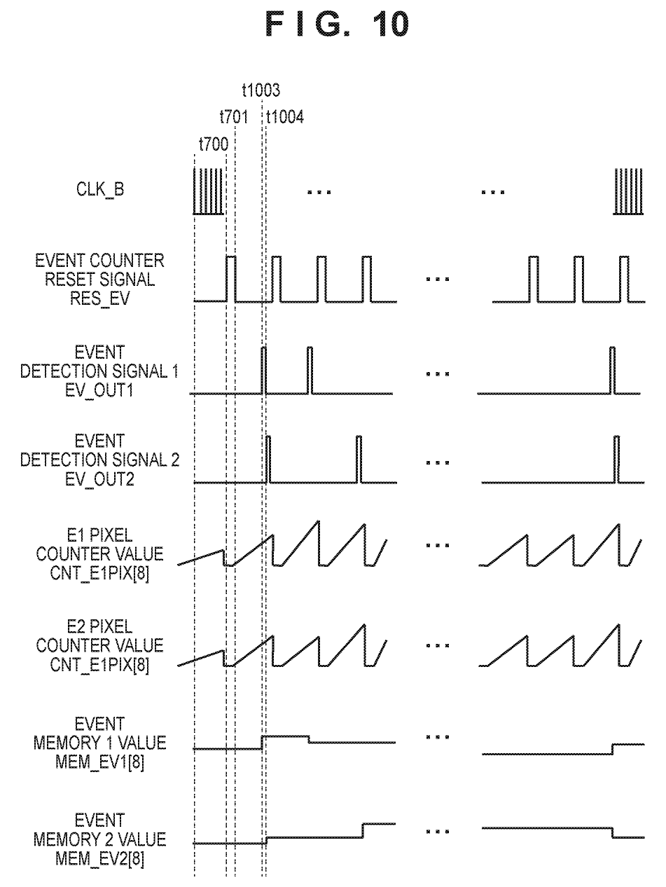

FIG. 10 is a timing chart showing an operation according to the second embodiment. The operation of the F pixel is the same as in the first embodiment, and a description thereof will be omitted. The reset operation for the event detection counter of the E pixel from time t700 to time t701 corresponds to the reset operation for the event detection counter of the H pixel in the first embodiment.

Time t1003 is event detection time of the E1 pixel. A count value CNT_E1PIX[8] of the E1 pixel at a reference time is held in the event memory 1 area MEM_EV1[8] in advance as a reference value. A subtraction unit 240 calculates a difference value between the count value CNT_E1PIX[8] and the reference value in the event memory 1 area MEM_EV1[8] (CNT_E1PIX[8] - MEM_EV1[8]), and outputs it to a comparison unit 260. The comparison unit 260 compares the difference value with a threshold output from a threshold control unit 250. If the difference value is larger than the threshold, it is determined to be on-event, and an event is detected. If an event is detected, an event detection signal EV_OUT1 is switched from low level to high level. In accordance with this, the E1 pixel count value CNT_E1PIX[8] in this event detection is saved in the event memory 1 area MEM_EV1[8] as a new reference value.

Timet1004 is event detection time of the E2 pixel. The operation performed for the E1 pixel at time t1003 is performed for the E2 pixel. If an event is detected, an event detection signal EV_OUT2 is switched from low level to high level. The event detection signal EV_OUT2 is input to an IF unit 270. The reference value stored in the additional event memory 2 area MEM_EV2 is updated.

During a period when the image memory area MEM_FL[11] used for image signal accumulation is allocated to the additional event memory 2 area MEM_EV2, the H pixel can be used as the E pixel for event detection. During this period, the E pixel can be used for event detection but cannot be used for image signal acquisition. However, since event detection can be performed using a larger number of pixels than in the first embodiment, the resolution of event detection can be increased, and the accuracy of event detection can be improved.

### Third Embodiment

This embodiment provides a photoelectric conversion apparatus that can dynamically switch the operation according to the first embodiment and the operation according to the second embodiment. It is possible to perform event detection with high resolution, and achieve both image data acquisition and event detection without performing pixel complementing processing.

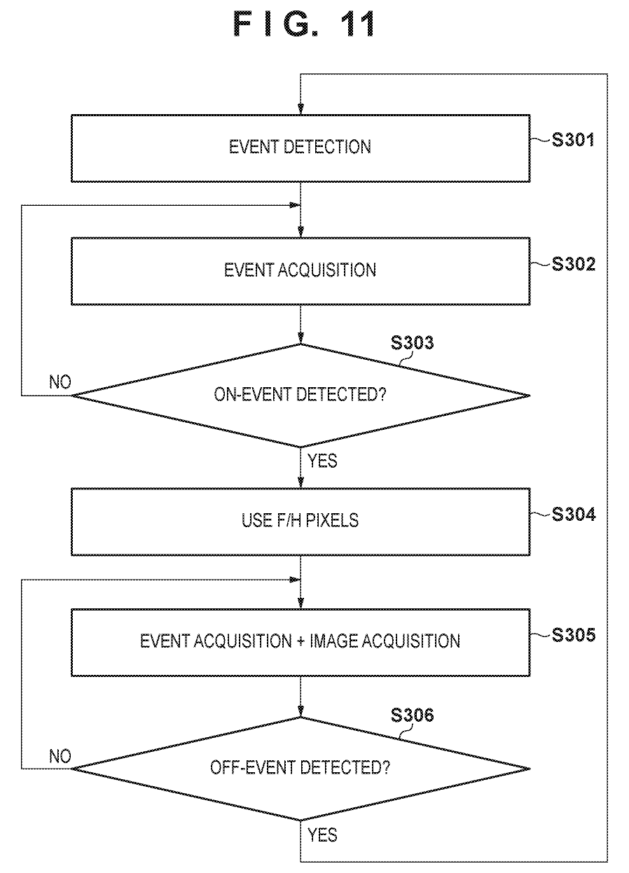

An operation according to the third embodiment will be described with reference to the flowchart shown in FIG. 11. First, as described in the second embodiment, an image memory area MEM_FL[11] is operated as an event memory 1 area MEM_EV1, and event detection by the H pixel is performed (step S301). Event detection is repeated until on-event is detected (steps S302 and S303). If on-event is detected, the operation is switched to use the H pixels and F pixels as in the first embodiment (step S304). After that, an operation of simultaneously acquiring an event detection signal and an image signal is repeated (step S305). If the difference value between the event detection signal and the reference value becomes equal to or smaller than a predetermined threshold, it is determined that off-event is detected (step S306). At this time, the mode can be switched to the mode for performing event detection by the H pixel (step S301) as described in the second embodiment. The operation according to this embodiment may be set and operated individually for each pixel block 130.

In the mode described in the second embodiment, in which the number of pixels for event detection can be increased more than usual, the event detection accuracy can be improved and occurrence of an event to acquire a frame image (that is, "on-event") can be detected with high accuracy. Furthermore, if an event is detected, both event detection and image data acquisition can be performed by the F pixel and the H pixel. Hence, degradation of image quality can be suppressed without performing image signal complementing processing.

### Fourth Embodiment

Differences from the first embodiment will mainly be described. In this embodiment, image data acquisition and event detection can be performed simultaneously without using the addition unit 230.

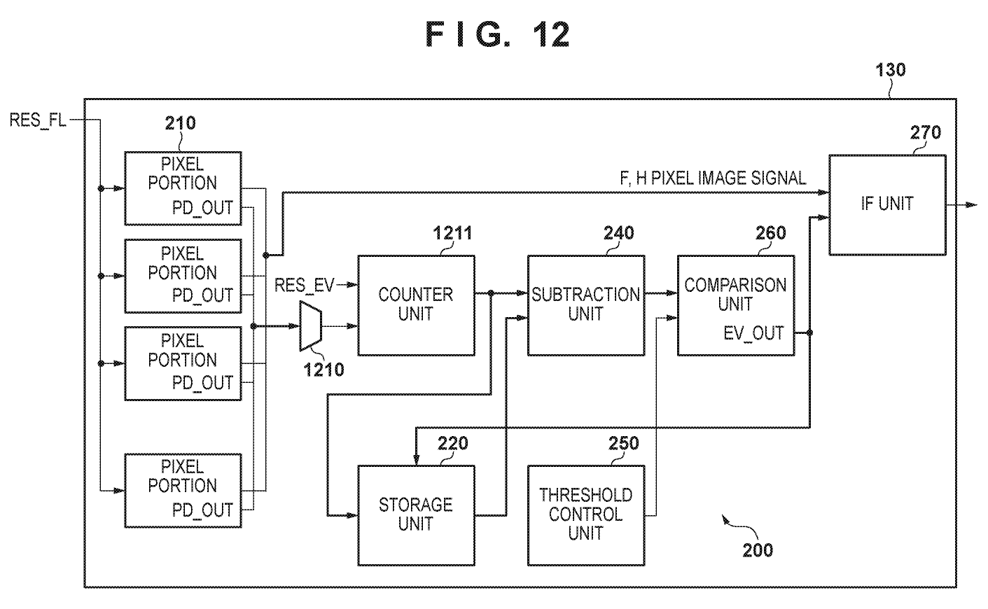

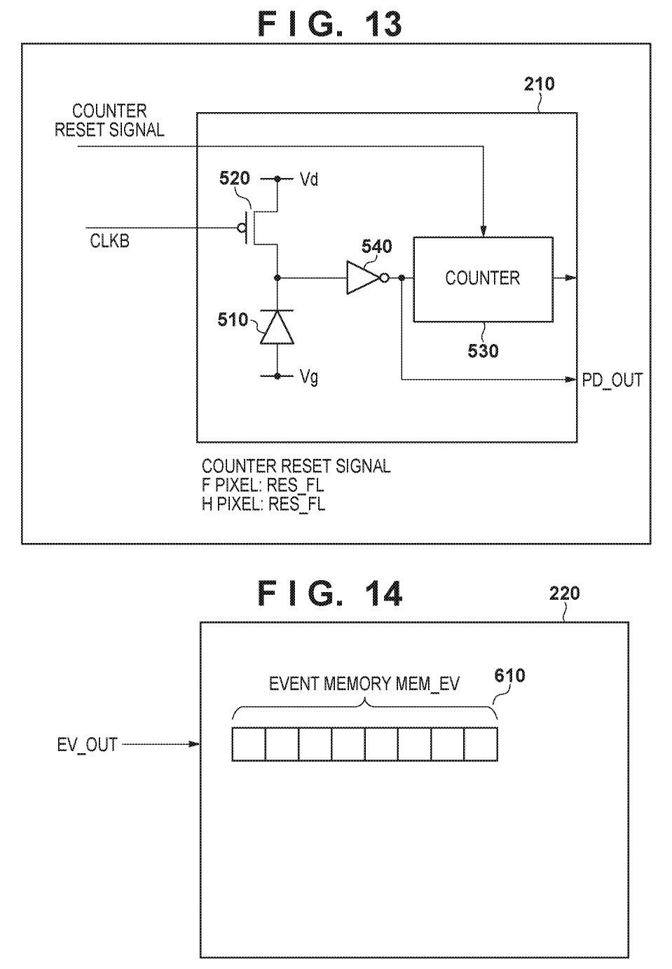

This embodiment will be described with reference to FIGS. 12 and 13. FIG. 12 shows the configuration of a pixel block 130. The pixel block 130 can include pixel portions 210, a determination unit 200 that determines an event, an output interface unit 270, a selector 1210, and a counter unit 1211. The determination unit 200 can include a storage unit 220, a subtraction unit 240, a threshold control unit 250, and a comparison unit 260.

Here, this embodiment will be described using an H pixel arranged in the pixel portion 210 as an example. Note that in this embodiment, H pixels and F pixels can be appropriately arranged in the pixel block 130. When light enters, a detection unit, which includes a photoelectric conversion element 510, a quenching element 520, and an inverter 540, outputs a light detection signal PD_OUT to the selector 1210. The light detection signals PD_OUT from respective H pixels are input to the selector 1210. The selector 1210 can select which of the light detection signals PD_OUT from the pixel portions 210 is to be output. The selector 1210 can be controlled to select the pixel to be used for event detection in accordance with information indicating a defect related to the pixel, the type of color filter provided in the pixel, or the frequency or accuracy of event detection. The light detection signal PD_OUT from the pixel portion 210 selected by the selector 1210 is input to the counter unit 1211 that performs counting for event detection. The counter unit 1211 counts the number of light detection signals PD_OUT. Since the event detection data may be shorter than the image data, the image data may have a data length of 11 bits and the event detection data may have a data length of 8 bits. Accordingly, the counter unit 1211 may be an 8-bit counter.

The circuit of the H pixel will be described with reference to FIG. 13. In this embodiment, a counter 530 of the H pixel has a bit length of 11 bits, and the count value can be output as an image signal. When using the count value of the counter 530 as the image signal, the counter 530 can be controlled by an image counter reset signal RES_FL. The counter 530 counts the light detection signal PD_OUT, which is the output of the inverter 540, and is reset by the counter reset signal RES_FL. Similar to the count value from the F pixel, which is output at each image readout cycle, the count value of the counter 530 of the H pixel can be directly input to the IF unit 270 from the pixel portion 210. In this embodiment, the image memory area MEM_FL[11] for image is not required. Accordingly, the memory capacity of the storage unit 220 can be reduced compared to the first embodiment. The output of the inverter 540 is input to the counter 530, and also input as the light detection signal PD_OUT to the selector 1210 via the output terminal of the H pixel, where the output is used for event detection.

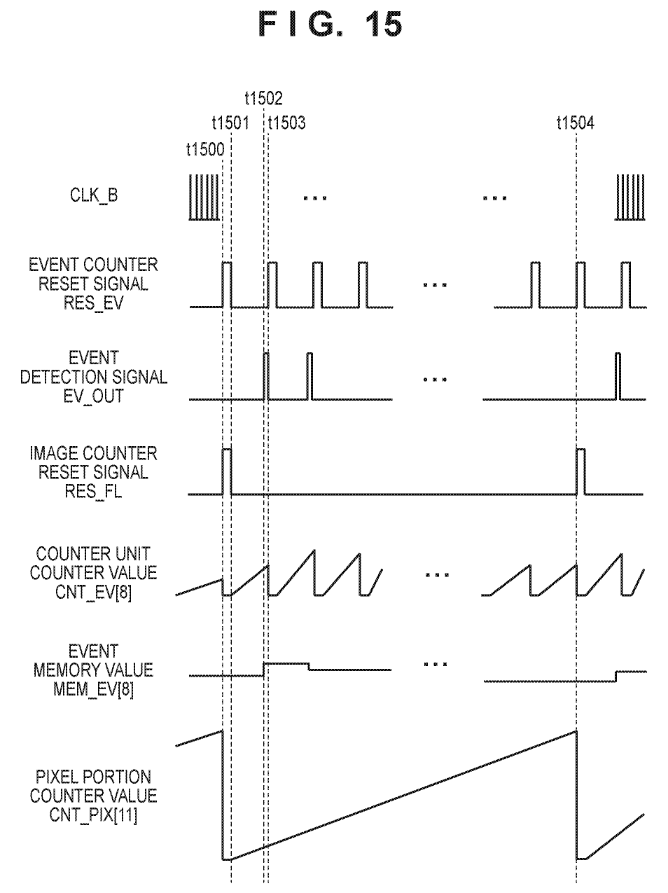

FIG. 15 is a timing chart showing an operation according to the fourth embodiment, and corresponding to FIG. 7 in the first embodiment. From time t1500, a reset period for each of the counter unit 1211 and the counter 530 of the pixel portion 210 starts. At time t1500, an event counter reset signal RES_EV and the image counter reset signal RES_FL change from low level to high level. The counter unit 1211 is reset by the event counter reset signal RES_EV. The counter 530 of the pixel portion 210 is reset by the image counter reset signal RES_FL.

At time t1501, the event counter reset signal RES_EV and the image counter reset signal RES_FL change from high level to low level, and an event detection period and a pixel signal count period start. When a photon enters the photoelectric conversion element 510 in the pixel portion 210, the counter 530 counts up. The counter 530 is controlled by the image counter reset signal RES_FL, performs counting until the count period ends (t1504), and outputs a count value corresponding to the image signal according to the incident light amount. At the same time, when the photon enters the photoelectric conversion element 510, the light detection signal PD_OUT is output and input to the counter unit 1211 via the selector 1210. The counter unit 1211 counts the light detection signal PD_OUT, and outputs a count value for event detection. The selector 1210 can select the pixel to be assigned for event detection. The selector may select multiple pixels. In the pixel block 130, allocation of the H pixels and F pixels can be changed for each event frame or in accordance with the magnitude of incident light amount or information of the defect pixel.

At time t1502, event detection is determined. The operation here is performed similar to that for the count value CNT_HPIX[8] of the H pixel in the first embodiment. That is, the subtraction unit 240 calculates the difference between the count value CNT_EV[8] of the counter unit 1211 and a reference value, and the comparison unit 260 compares the difference with a threshold. Thus, occurrence of an event is determined. If occurrence of an event is detected, the reference value is updated.

At time t1503, the counter unit 1211 for event detection is reset. The event counter reset signal changes from low level to high level, and the count value CNT_EV[8] of the counter unit 1211 is reset. Thus, the counter unit 1211 transitions to the next event detection cycle. On the other hand, in order to acquire an image signal, the counter of each of the F pixel and the H pixel continues to count a count value CNT_PIX[11].

At time t1504, the image signal count period ends. The count value CNT_PIX is output from the pixel portion 210 to the IF unit 270 as the image signal of each of the F pixel and the H pixel, and is output to the outside of the pixel block.

In this embodiment, the selector 1210 and the counter unit 1211 are added. However, since the addition unit 230 is not required, the memory capacity of the storage unit 220 can be reduced by the amount of the image memory area. Therefore, it is possible to simultaneously achieve event detection and image data acquisition with fewer components.

### Fifth Embodiment

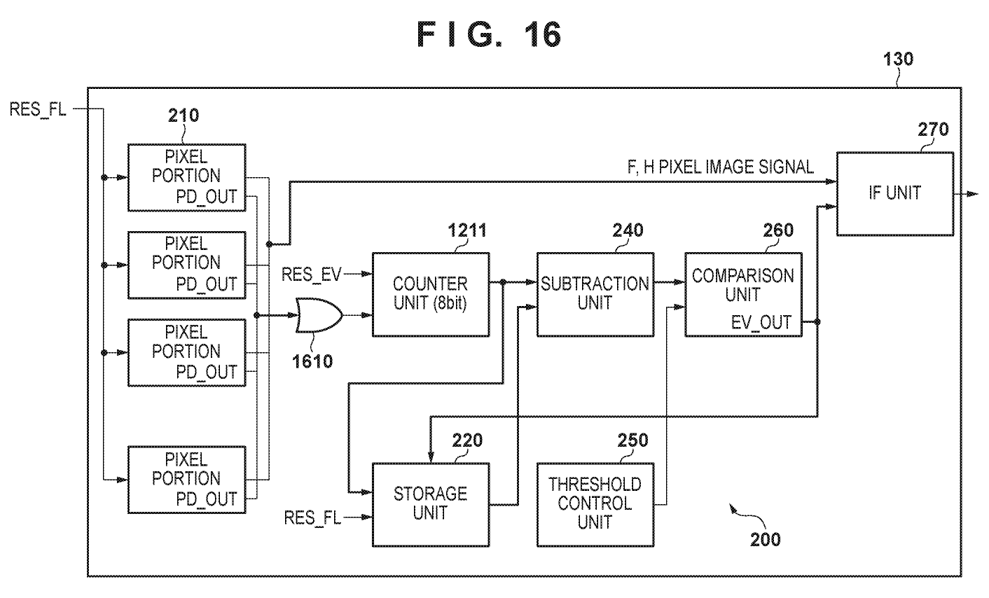

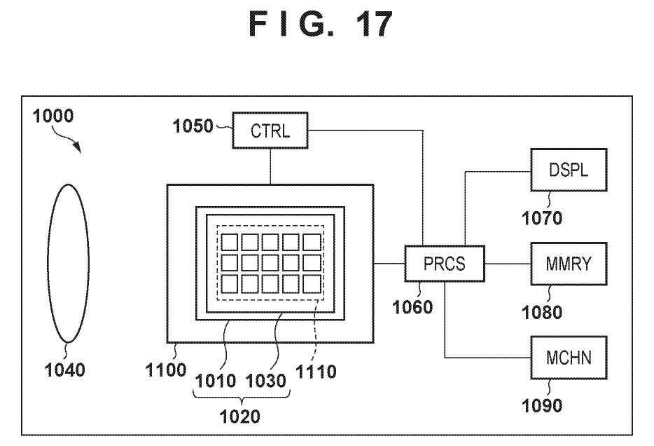

In this embodiment, event detection is performed by taking the logical OR of light detection signals PD_OUT from a plurality of pixels. With reference to FIG. 16, the configuration of a pixel block 130 according to this embodiment will be described. In place of the selector 1210 provided in the fourth embodiment, an OR circuit 1610 is provided. The pixel block 130 can include pixel portions 210, a determination unit 200, an output interface unit 270, a counter unit 1211, and the OR circuit 1610. The determination unit 200 can include a storage unit 220, a subtraction unit 240, a threshold control unit 250, and a comparison unit 260.

At low brightness, the influence of noise on the output signal from the pixel portion is large, so that the S/N ratio is poor and the event detection accuracy decreases. To prevent this, the OR circuit 1610 takes the logical OR of the light detection signals PD_OUT output from the plurality of pixel portions 210, and the counter unit 1211 counts the output of the OR circuit 1610. Since the logical OR of the detection signals from the plurality of pixels is taken as the count value, the incident light amount seems to increase, and the S/N ratio at low brightness improves. Based on the count value, the determination unit 200 determines occurrence of an event. For determination, the subtraction unit 240 subtracts a reference value from the count value. Event determination is performed by the comparison unit 260 comparing the value after subtraction with a threshold. At low brightness, the number of photons entering one pixel is small, so that the data length of the counter unit may not be increased and remain at 8 bits. The number of pixels for taking the logical OR may be changed in accordance with the brightness. This can improve the event detection accuracy particularly at low brightness.

### Example of Application of Photoelectric Conversion Apparatus to Equipment

The following is a description of equipment 1000 that includes a semiconductor apparatus 1100 including a package 1020 on which a semiconductor chip 1110 including a semiconductor integrated circuit is mounted, as shown in FIG. 17. The semiconductor chip 1110 is accommodated in the package 1020 and mounted on the equipment 1000. In the arrangement shown in FIG. 17, the semiconductor chip 1110 includes the photoelectric conversion apparatus according to the embodiment described above. The semiconductor apparatus 1100 can include the package 1020 including a base 1010 on which the semiconductor chip 1110 is fixed and a light transmissive member 1030 such as glass that faces the semiconductor chip 1110. The package 1020 can be provided with joining members such as wires and bumps that connect inner leads provided on the base 1010 to terminals such as pad electrodes provided on the semiconductor chip 1110.

The equipment 1000 can include at least one of an optical apparatus 1040, a control apparatus 1050, a processing apparatus 1060, a display apparatus 1070, a storage apparatus 1080, and a mechanical apparatus 1090. The optical apparatus 1040 may be implemented by, for example, a lens, a shutter, and a mirror. The control apparatus 1050 controls the semiconductor chip 1110. The control apparatus 1050 may be a semiconductor device such as an ASIC.

The processing apparatus 1060 processes a signal output from the photoelectric conversion apparatus included in the semiconductor chip 1110. The processing apparatus 1060 is a semiconductor device such as a CPU or an ASIC for forming an Analog Front End (AFE) or a Digital Front End (DFE). An image may be generated based on an image capturing signal at the time of detecting an event. The display apparatus 1070 is an EL display device or a liquid crystal display device that displays an information image obtained by the semiconductor chip 1110. The storage apparatus 1080 is a magnetic device or a semiconductor device that stores the information image obtained by the semiconductor chip 1110. The storage apparatus 1080 is a volatile memory such as an SRAM or a DRAM, or a nonvolatile memory such as a flash memory or a hard disk drive.

The mechanical apparatus 1090 includes a moving or propulsion unit such as a motor or an engine. In the equipment 1000, the signal output from the semiconductor chip 1110 is displayed on the display apparatus 1070 or transmitted to an external apparatus by a communication apparatus (not shown) included in the equipment 1000. Hence, the equipment 1000 may further include the storage apparatus 1080 and the processing apparatus 1060 in addition to the memory circuits and arithmetic circuits included in the semiconductor chip 1110. The mechanical apparatus 1090 may be controlled based on the signal output from the semiconductor chip 1110.

The equipment 1000 is suitable for electronic equipment such as an information terminal which has a shooting function, for example, a smartphone or a wearable terminal, or a camera, for example, an interchangeable lens camera, a compact camera, a video camera, or a monitoring camera. The mechanical apparatus 1090 in the camera can drive the components of the optical apparatus 1040 in order to perform zooming, an in-focus operation, and a shutter operation. Alternatively, the mechanical apparatus 1090 in the camera can move the optical apparatus 1040 in order to perform an anti-vibration operation.

Furthermore, the equipment 1000 can be transportation equipment such as a vehicle, a ship, or an airplane. The mechanical apparatus 1090 in the transportation equipment can be used as a moving apparatus. The equipment 1000 as the transportation equipment is suitable for equipment that transports the semiconductor chip 1110 or equipment that uses a shooting function to assist and/or automate drive steering. The processing apparatus 1060 for assisting and/or automating drive steering can perform, based on the information obtained by the semiconductor chip 1110, processing for operating the mechanical apparatus 1090 as a moving apparatus. Alternatively, the equipment 1000 may be medical equipment such as an endoscope, measurement equipment such as a distance measurement sensor, analysis equipment such as an electron microscope, office equipment such as a copy machine, or industrial equipment such as a robot.

According to the present disclosure, it is possible to provide a technique capable of performing detection of an event and acquisition of an image signal temporally in parallel and suppressing degradation of the image signal.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A photoelectric conversion apparatus in which a plurality of pixel blocks, each including a plurality of first pixels, a determination unit, and an addition unit, are arranged,
wherein each of the plurality of first pixels includes a first detection unit configured to detect light and output a detection signal, and a first counter configured to count the detection signal output per a first time period and output a count value,
the determination unit performs detection of an event based on the count value of the first counter, and
the addition unit accumulates outputs of the first counter over a second time period, and outputs the accumulated output as an image signal.

2. The photoelectric conversion apparatus according to claim 1,
wherein the pixel block further includes a plurality of second pixels, and
each of the plurality of second pixels includes a second detection unit configured to detect light and output a detection signal, and a second counter configured to count the detection signal output per the second time period and output a counted value as an image signal.

3. The photoelectric conversion apparatus according to claim 1, wherein the pixel block further includes a storage unit, and the storage unit includes a first area allocated to store a reference value for detection of the event for each of the plurality of first pixels, and a second area allocated to store the accumulated value for each of the plurality of first pixels.

4. The photoelectric conversion apparatus according to claim 3, wherein the reference value is updated each time the event is detected.

5. The photoelectric conversion apparatus according to claim 3, wherein at least a part of the area allocated to the second area of the storage unit can be changed to the first area.

6. The photoelectric conversion apparatus according to claim 1, wherein the pixel block has a first mode for performing detection of the event using the first pixel and a second mode for performing detection of the event and output of the image signal using the first pixel, and the second mode is started in accordance with detection of the event in the first mode.

7. The photoelectric conversion apparatus according to claim 1, wherein the first time period is shorter than the second time period.

8. The photoelectric conversion apparatus according to claim 1, wherein the first time period during which detection of the event is performed and the second time period during which accumulation by the addition unit is performed partially overlap each other.

9. A photoelectric conversion apparatus in which a plurality of pixel blocks, each including a plurality of pixels, a determination unit, a selector, and a first counter, are arranged,
wherein each of the plurality of pixels includes a detection unit configured to detect light and output a detection signal to the selector,
the selector selects and outputs the detection signal,
the first counter counts an output of the selector and outputs a count value, and
the determination unit performs detection of an event based on the count value.

10. The photoelectric conversion apparatus according to claim 9, wherein at each of the plurality of pixels further includes a second counter, and the second counter counts the detection signal and outputs a counted value as an image signal.

11. A photoelectric conversion apparatus in which a plurality of pixel blocks, each including a plurality of pixels, a determination unit, an OR circuit, and a first counter, are arranged,
wherein each of the plurality of pixels includes a detection unit configured to detect light and output a detection signal to the OR circuit,
the OR circuit outputs a logical sum of the detection signals,
the first counter counts an output of the OR circuit, and outputs a count value, and
the determination unit performs detection of an event based on the count value.

12. The photoelectric conversion apparatus according to claim 11, wherein each of the plurality of pixels further includes a second counter, and the second counter counts the detection signal and outputs a counted value as an image signal.

13. The photoelectric conversion apparatus according to claim 1, further comprising a threshold control unit capable of storing and changing a threshold for detection of the event.

14. Equipment comprising:
a photoelectric conversion apparatus defined in claim 1; and
a processing apparatus configured to process a signal output from the photoelectric conversion apparatus.
